(19) United States
(12) Patent Application Publication
(10) Pub. No.: US 2025/0010415 A1
(43) Pub. Date: Jan. 9, 2025

(54) TOOL SYSTEM FOR FITTING INTERIOR COMPONENTS WITH CONNECTOR CLAMPS AND METHOD FOR CHANGING TOOLS

(71) Applicant: Lisa Dräxlmaier GmbH, Vilsbiburg (DE)

(72) Inventors: Christian SELMEIER, Bodenkirchen (DE); Dominic HÄUPLIK, Vilsbiburg (DE); Stefan STRASSER, Kumhausen (DE); Georg ESTERMEIER, Neumarkt-St. Veit (DE); Simon HERRNREITER, Frontenhausen (DE)

(73) Assignee: Lisa Dräxlmaier GmbH, Vilsbiburg (DE)

(21) Appl. No.: 18/762,188

(22) Filed: Jul. 2, 2024

(30) Foreign Application Priority Data
Jul. 3, 2023 (DE) 10 2023 117 436.3

(51) Int. Cl. B23Q 3/155

(52) U.S. Cl. CPC B23Q 3/15503; B23Q 3/1554; B23Q 2003/155407

(57) ABSTRACT

A tool system for fitting interior components, in particular dashboards or parts thereof, with connector clamps, includes a tool to hold an interior component in such a way that the interior component can be fitted with connector clamps. The tool system further includes a lifting and centering unit for holding the tool, and the lifting and centering unit includes lifting elements for lifting the tool from a working position into an alternating position and centering elements for centering the tool in the working position. The present disclosure also relates to a method for changing a tool of such a tool system.

### CROSS-REFERENCE TO RELATED APPLICATIONS

This application claims priority to and the benefit of DE 10 2023 117 436.3 filed on Jul. 3, 2023. The disclosure of the above-referenced application is incorporated herein by reference.

### FIELD

The present disclosure relates to a tool system for fitting interior components with connector clamps and to a method for changing a tool of such a tool system.

### BACKGROUND

The statements in this section merely provide background information related to the present disclosure and may not constitute prior art.

Different production methods are used to manufacture interior components in motor vehicles. Interior components, in particular dashboards or parts thereof, are manufactured as plastic parts by injection molding. Various connector elements are used to connect such parts with other components within a motor vehicle. A frequently used connector element is a clamp, such as a threaded clamp. Such a clamp is usually a molded sheet metal part that is attached to elements or sections of the plastic part and has a thread that can then be used to screw on other components. This means that the interior components, in particular injection molded parts, can be coupled with other vehicle components. It is also possible, for example, to attach wiring harnesses and other elements to interior components using such clamps. The threaded clamps are well suited for this purpose and are inexpensive.

To equip such an interior component, for example a dashboard, with the appropriate threaded clamps, so-called automatic clamp insertion machines are used. These are tool systems that are specially adapted to the respective interior component, pick it up in a precise position and then enable the clamps to be attached to the corresponding positions on the interior component using a robot arm. As a high degree of positioning accuracy is desired, such tool systems are specially adapted to the interior component to be manufactured or fitted. If the interior component is changed or the production line is changed, the entire tool system for clamp insertion must also be replaced accordingly. This is time-consuming and extremely cost-intensive. In particular, this also makes it more difficult to convert a production line to other vehicle components. Another disadvantage is that if the tool system needs repair or has an issue, the entire production line is shut down for a longer period of time, as the tool system, which is integrated into the production system, generally requires time-consuming maintenance or repair.

### SUMMARY

This section provides a general summary of the disclosure and is not a comprehensive disclosure of its full scope or all of its features.

The present disclosure provides a tool system for fitting interior components with connector clamps that achieves greater flexibility in production systems. Furthermore, the present disclosure provides a method for changing a tool of such a tool system.

Thus, the present disclosure provides a tool system for fitting interior components, in particular dashboards or parts thereof, with connector clamps, such that the tool system includes: a tool which is adapted to hold an interior component in such a way that the interior component can be fitted with connector clamps, and a lifting and centering unit for holding the tool, such that the lifting and centering unit has lifting elements for lifting the tool from a working position into an alternating position and centering elements for precisely centering the tool in the working position.

The present disclosure provides a tool system in which the tool can be replaced quickly and easily. The tool system is to be able to transfer the tool to a working position in which the function of fitting the interior component with a connector clamp takes place. The tool provides high positioning accuracy when holding interior components so that the connector clamps can be fitted with pinpoint accuracy. The centering elements, onto which the tool can be lowered into the working position, are provided for this purpose. The tool is accordingly positioned in the working position, so that there are no disadvantages compared to tool systems that were previously fully integrated into a production system.

The particular advantage, however, lies in the function of the tool system to lift the tool into the alternating position via the lifting unit, so that the tool leaves the centering elements and is then, in one example, freely movable. In the alternating position, the tool can then be transferred to a swap body vehicle, for example, so that the tool can be replaced very quickly and easily. This makes it easier to maintain the tool without major interruptions to the production process, facilitates production lines to be changed quickly and increases the reliability of a production system for interior components. The present disclosure also increases flexibility at production sites, as the ability to simply change tools means that a production plant can be converted to produce a different interior component or a completely different vehicle line within a short space of time. This means that short-term increases in component call-offs by vehicle manufacturers can be easily compensated for.

The present disclosure provides for the lifting and centering unit to be installed in the production line in a stationary but removable manner. The actual tool that holds the interior component and keeps it in the correct position for fitting with connector clamps, on the other hand, is replaceable and can be removed from the lifting and centering unit.

Specifically, in one example of the present disclosure, the lifting and centering unit may have a lifting floor for lifting and lowering the tool. The lifting floor can be controlled in such a way that the tool can be lowered onto the centering pins of the lifting and centering unit and the lifting floor can be released from the tool. The lifting floor can accordingly be used to lower the tool from the alternating position to the working position and, conversely, to lift it from the working position to the alternating position. By additionally lowering the lifting floor further in the working position of the tool, the contact between the lifting floor and the tool is released so that the tool rests on the centering pins alone at best. This avoids positioning inaccuracies and increases the positioning precision of the tool in the working position.

To facilitate a quick and easy tool change, it is advantageous if the lifting and centering unit, in particular the lifting floor, has rails for holding and transferring the tool to a swap body vehicle. Rails are provided both on the lifting and centering unit and on the swap body vehicle, which can be aligned with each other. The rails make it very easy to transfer the tool from the lifting and centering unit to the swap body vehicle and vice versa. In particular, workers are not burdened by the weight of the tool.

In one example, a swap body vehicle is provided. The swap body vehicle can be provided to hold the tool in the alternating position. The swap body vehicle makes it possible to pick up the tool when it has been transferred to the alternating position by the lifting elements. The swap body vehicle can then be used to transfer the tool to a warehouse. The swap body vehicle can be moved, especially on wheels. The tool system can have several swap body vehicles that carry different tools so that tools can be changed quickly.

In this context, it should be mentioned that tools for clamp insertion are quite complex and contain a large number of pneumatic and electrical components. This increases the weight of the tool, but the aligned rails on the lifting and centering unit and the swap body vehicle still allow the tool to be changed easily and effortlessly.

In one example of the present disclosure, the lifting and centering unit has at least one damping element for the tool. On the one hand, the damping element can form an end stop for the tool and also provides that the tool is slowly braked when it moves onto the lifting and centering unit before it reaches its end position. This inhibits damage to the tool.

In this respect, it is advantageous if the damping element is arranged in the region of a longitudinal end of the rails of the lifting and centering unit.

The damping element, in one example, has a preliminary bearing. The preliminary bearing is particularly suitable for absorbing lateral forces that occur when the lifting floor is released from the tool. The tool, which is braked by the damping element when it is pushed onto the lifting and centering unit, rests against the damping element, in one example, its preliminary bearing, when the lifting floor is lowered into the working position. When the tool rests on the centering elements and the lifting floor is lowered further to completely relieve the tool, a relative movement between the damping element and the tool occurs. The preliminary bearing is provided to compensate for the resulting transverse forces acting on the damping element. The preliminary bearing can be mounted on a shock absorber, in particular screwed on. The shock absorber is, in one example, connected to the damping element or forms part of the damping element. In particular, the preliminary bearing can be a side load adapter that allows an angular offset between its tip and the damping element. It is also possible that the preliminary bearing includes a roller or a rotatably mounted ball, each of which rolls along an end wall of the tool when the lifting floor moves away from the tool.

Furthermore, the lifting and centering unit can have at least one proximity sensor for detecting the position of the tool on the lifting and centering unit, in particular in the region of a longitudinal end of the rails. The proximity sensor can be used to provide that the tool is in the correct position in the alternating position so that the centering elements encounter the corresponding centering openings of the tool effectively when the tool is lowered into the working position and the centering elements in particular are not damaged.

In one example, two proximity sensors arranged in parallel are provided. The tool can have an opening corresponding to at least one of the proximity sensors. The proximity sensors can be connected to a control unit in such a way that the correct alignment and position of the tool on the lifting and centering unit can be detected in the alternating position. The two proximity sensors arranged in parallel not only indicate whether the tool is in the correct position. Particularly in conjunction with the opening on the tool, it is also possible to determine whether the tool has been pushed onto the lifting and centering unit with the correct alignment. The proximity sensors can be designed as induction sensors.

The tool can have two end faces that are arranged opposite each other in a direction of movement of the tool that runs parallel to the rails of the lifting and centering unit. In other words, the tool can have a front end in the direction of movement and a rear end in the direction of movement. The opening corresponding to one of the proximity sensors is, in one example, arranged on one of the end faces. The opening can be designed as a blind hole in particular. However, it can also be a through opening in a frontal wall of the tool. If, for example, one proximity sensor recognizes that there is a preset distance between the tool and the proximity sensor and at the same time the other proximity sensor detects a greater distance because it is directed towards the opening, it can be assumed that the tool is correctly positioned and aligned. However, if both proximity sensors indicate the preset distance, then the tool is incorrectly aligned and should be pushed onto the lifting and centering unit again, rotated by 180 degrees around a vertical axis.

In one example of the present disclosure, the lifting elements for lifting the tool from a working position to an alternating position includes at least one lifting cylinder and a guide arranged parallel to it. The lifting cylinder can be a hydraulic cylinder and/or a pneumatic cylinder, for example. Such lifting cylinders may have limited positioning precision. In order to achieve a swiveling-free and precise lifting and lowering, an additional guide is, in one example, provided. The guide can be designed as a linear guide and in particular include several linear ball bearings. The linear guide provides a linear movement of the lifting unit so that the tool also performs a linear movement in relation to the lifting and centering unit.

The lifting and centering unit and the tool, in one example, each have a uniform interface for electrical and pneumatic connection. Several pneumatic and electrical components are often integrated into the tool for clamp insertion. In order to control these components, an electrical and pneumatic connection between the tool and the corresponding sources is desired, which is usually done using plug-in connections. To provide that the tool can be changed as quickly and easily as possible, in one example, the lifting and centering unit as the source on the one hand and the tool as the receiver on the other hand each have a standardized connection that combines pneumatic and electrical connections.

For example, a connecting cable with pneumatic and electrical connecting lines can be provided on the lifting and centering unit, which can be coupled to the tool via a single plug connection. To change the tool, the tool is first electrically and pneumatically disconnected from the lifting and centering unit via a single plug. The tool can then be lifted into the alternating position and pushed onto a swap body vehicle. The new tool can then be moved to the lifting and centering unit in reverse order through the swap body vehicle, pushed onto the lifting and centering unit through the aligned rails and then lowered onto the centering pins of the lifting and centering unit using the lifting unit. The connection cable of the lifting and centering unit is then plugged into the tool through the single connection, so that all electrical and pneumatic connections between the lifting and centering unit and the tool are established with a manual plug-in process.

In order to secure the tool either on the lifting and centering unit and/or the swap body vehicle and, in particular, to inhibit the tool from moving unintentionally along the rails, the tool and/or the lifting and centering unit can have at least one movable, in particular spring-loaded, locking element for locking the tool on the lifting and centering unit and/or on the swap body vehicle. For example, after being pushed onto the lifting and centering unit, the tool can be secured with the locking element before it is lowered onto the centering elements of the lifting and centering unit via the lifting elements. This also inhibits the tool from shifting during lowering and possibly not encountering the centering elements correctly.

In a further example of the present disclosure, the lifting and centering unit includes a lifting part with the lifting elements and the lifting floor and a centering part with the centering elements. At least the lifting floor, in particular the entire lifting part, can in one example be arranged on the centering part in two positions rotated by 180 degrees about a vertical axis. By arranging the lifting part, or at least the lifting floor, in two different positions on the centering part, in particular by mounting it, the lifting and centering unit can be integrated into a production system in such a way that a tool change to different sides is possible. If the lifting floor is arranged in the first position on the centering part, a tool can be pushed onto the lifting and centering unit from the left, for example, whereas it can be pushed on from the right if the lifting floor is arranged in the second position on the centering part.

For a high degree of flexibility in the production of interior components, it has also proven to be advantageous if several tools are provided for different interior components, which interact with a lifting and centering unit and at least one swap body vehicle for changing tools. In particular, several different tools can be provided in a store, which can accommodate different interior components for fitting with connector clamps. Depending on the type of production standard, the desired tool can be transported from the store to the production system using a swap body vehicle. There, the tool is moved onto the lifting and centering unit, whereby the lifting and centering unit is in an alternating position. After pushing and locking the tool onto the lifting and centering unit, the lifting and centering unit is lowered into the working position, whereby the tool is positioned precisely through the centering elements. As soon as the tool is pneumatically and electrically integrated into the production system, the assembly of the interior component for which the tool is intended can begin.

According to an ancillary aspect, the present disclosure further relates to a method for changing a tool of a tool system, in particular a tool system explained above, such that the method includes the following: lifting of a lifting floor by lifting elements of a lifting and centering unit into an alternating position, pushing a tool onto the lifting floor, detection of the alignment and position of the tool on the lifting and centering unit via proximity sensors, positioning the tool at a preset distance from the proximity sensors, locking the tool on the lifting floor, lowering the lifting floor via the lifting elements until the tool is positioned on the centering elements, and further lowering of the lifting floor to completely relieve the tool.

In particular, the complete relief of the tool by further lowering the lifting floor provides high centering accuracy.

In the method according to the present disclosure, it can be provided that the pushing on of the tool is slowed down or stopped by at least one damping element. The damping elements can also be pre-tensioned for or by locking the tool on the lifting floor, so that high positional stability of the tool on the lifting and centering unit is guaranteed.

In one example after the lifting floor has been lifted and before the tool is pushed on, a previously inserted tool is removed from the lifting floor, in particular pushed onto a swap body vehicle.

The advantages and examples mentioned in connection with the tool system described above also apply analogously to the method. Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a tool and a lifting and centering unit of the tool system according to the present disclosure, with the tool in the working position;

FIG. 2 is a perspective view of the lifting and centering unit of the tool system according to FIG. 1;

FIG. 3 a perspective view of an optional swap body vehicle of the tool system according to FIG. 1;

FIG. 4 a detail perspective view of the lifting elements of the lifting and centering unit of the tool system according to FIG. 1; and

FIG. 5 a detail side view of a rail end section of the lifting and centering unit as shown in FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. The different and exemplary features described herein can be combined with one another in accordance with the present disclosure, insofar as this is technically expedient and suitable. This applies irrespective of whether the respective features are disclosed as unit and/or process features.

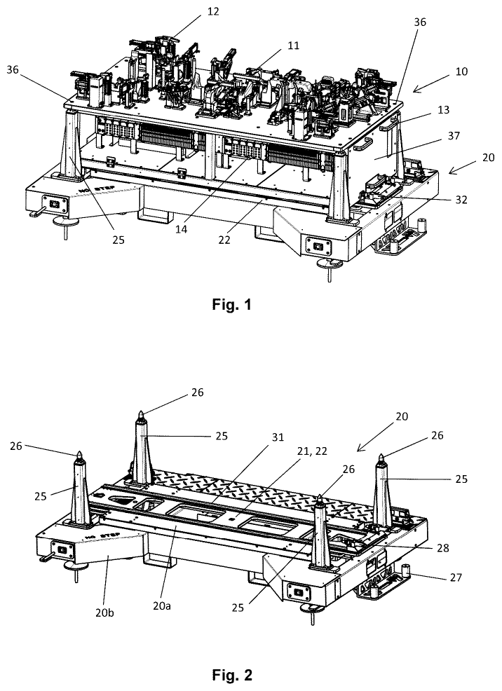

FIG. 1 shows a tool 10 of the tool system, which is set up to hold an interior component so that the interior component can be fitted with connector clamps. The tool 10 shown here has several holders 11 for the interior component and sliding units 12 for attaching the connector clamps. The tool can hold an interior component, such as a dashboard, in an exact position using the holders 11. The sliding units 12 can be fitted with connecting clamps and then fix the connecting clamps in preset positions on the interior component. The tool 10 can also be equipped without sliding units 12. The interior component can then be fitted with connector clamps, for example, by a collaborative robot, a so-called “cobot”, which is positioned outside the tool 10.

As can be seen in FIG. 1, the tool 10 includes extensive electronic components 14 for controlling the slider units 12. Several pneumatic components can also be provided. These are integrated into a box-like body of the tool 10.

The tool system also includes a lifting and centering unit 20, onto which the tool 10 is lowered in its working position as shown in FIG. 1. In particular, the lifting and centering unit 20 includes centering elements 25, which provide high-precision positioning of the tool 10 on the lifting and centering unit 20. The lifting and centering unit 20 and the tool 10 each have a uniform interface for electrical and pneumatic connection.

As can be clearly seen in FIG. 2, the centering elements 25 of the lifting and centering unit 20 each have a centering pin 26. The centering pin 26 can interact with corresponding centering openings 36 on the tool 10 to center the tool 10 precisely on the lifting and centering unit 20. The lifting and centering unit 20 also has lifting elements 21, the lifting elements 21 comprising a lifting floor 22, a lifting cylinder 23 and a guide 24 (FIG. 4). The lifting floor 22 carries rails 31, whereby corresponding rail wheels are provided on the tool 10 so that the tool 10 can be moved on the rails 31.

To provide that the tool 10 is arranged in the correct position on the lifting and centering unit 20, damping elements 28 are provided at one end of each of the rails 31. The damping elements 28 can have compression springs to provide appropriate damping when the tool 10 moves onto the lifting and centering unit 20.

The lifting and centering unit 20 can be functionally divided into a lifting section 20a and a centering section 20b. The lifting section 20a includes the lifting elements 21 and the lifting floor 22 and is used to lift and lower the tool. The lifting floor 22 includes the rails 31, the damping elements 28 and proximity sensors 29, which will be discussed in more detail later. The centering part 20b includes the centering elements 25 with the centering pins 26 and is used to keep the tool 10 centered in the working position.

The lifting part 20a, at least its lifting floor 22, can be separated from the centering part 20b. In particular, the lifting part 20a or the lifting floor 22 can be removed from the centering part 20b and reassembled in a position rotated by 180 about a vertical axis. This allows tools 10 to be pushed onto the lifting and centering unit 20 from different sides.

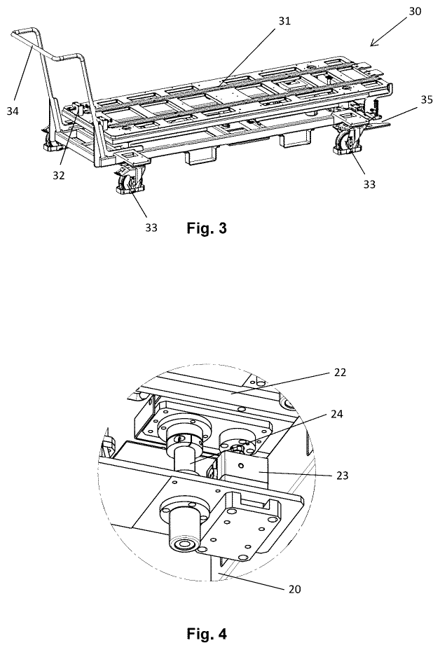

Part of the tool system can optionally be a swap body vehicle 30, which is shown in FIG. 3. The swap body vehicle 30 includes a platform with rails 31. Wheels 33 and a handle 34 are provided to enable the swap body vehicle 30 to be moved. The rails 31 on the swap body vehicle 30 each include a damping stop 32 at one end. The damping stops 32 can be designed to be damping, for example by having corresponding compression springs. The rails 31 of the swap body vehicle 30 are provided and aligned so that they can be aligned with the rails 31 of the lifting and centering unit 20, so that the tool 10 can be moved from the lifting and centering unit 20 to the swap body vehicle 30 and vice versa. The swap body vehicle 30 is provided for holding the tool 10 in an alternating position. The lifting and centering unit 20 has rails 31 configured to hold and transfer the tool 10 to a swap body vehicle 30.

FIG. 4 shows the lifting elements 21 of the lifting and centering unit 20 in detail. The lifting elements 21 are permanently mounted on the lifting and centering unit 20 and coupled to the lifting floor 22. Specifically, a lifting cylinder 23 and a guide 24 are provided, whereby the guide 24 is positioned parallel to the lifting cylinder 23.

The lifting cylinder 23 facilitates the lifting floor 22 to be lifted and lowered. The travel of the lifting cylinder 23 is dimensioned in such a way that the lifting floor 22 can be lifted so far that the tool 10 is out of engagement with the centering pins 26, i.e. is free of the centering pins 26. Conversely, the lifting cylinder 23 can lower the lifting floor 22 to such an extent that the tool 10 can be lowered onto the centering pins 26. The lifting cylinder 23 can also lower the lifting floor 22 further so that the lifting cylinder 23 can be positioned approximately 5 mm below the tool 10. This provides that the lifting floor 22 has no contact with the tool 10 in the working position of the tool 10. This inhibits the lifting floor 22 from influencing the position of the tool 10 in the working position.

Further lowering of the lifting floor 22 results in a relative movement between the damping elements 28 and an end face 37 of the tool 10. In order to inhibit damage to the damping elements 28, these each have preliminary bearings 28a, in particular in the form of side load adapters. The preliminary bearings 28a allow a tilting or swiveling movement, so that an angle between the tip of the respective preliminary bearing 28a and the damping element 28 results when the lifting floor 22 is lowered further. In this way, the damping element 28 is relieved of lateral forces. The damping elements 28 for the tool 10 are arranged in a region of a longitudinal end of a plurality of rails 31 of the lifting and centering unit 20. The damping element 28 has the preliminary bearing 28a for absorbing transverse forces when a lifting floor 22 is released from the tool 10.

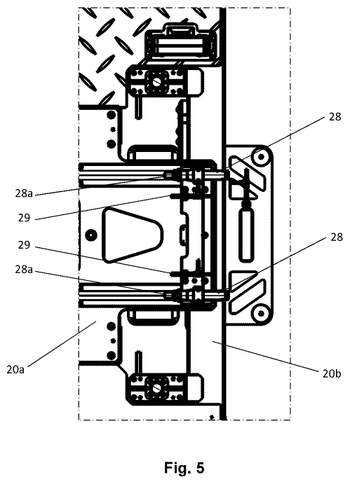

FIG. 5 shows the preliminary bearings 28a on the damping elements 28. It can also be seen that proximity sensors 29 are arranged parallel to the damping elements 28. Specifically, two proximity sensors 29 are provided, which are in one example designed as induction sensors. The proximity sensors 29 are in one example controlled in such a way that they recognize a correct position of the tool 10, i.e. the position of the tool 10 in relation to the distance to the proximity sensors 29 in the horizontal direction. Furthermore, the proximity sensors 29 can be signal-connected and controlled in such a way that they recognize a correct alignment of the tool 10. Correct alignment is understood to mean the spatial alignment of the tool 10 in relation to the lifting and centering unit 20. In the example shown here, the tool 10 is correctly aligned when the end face 37 points towards the proximity sensors 29 or the damping elements 28. However, if the end face 37 points in the opposite direction, the tool 10 is misaligned.

In order to detect the correct alignment of the tool 10, an opening can be formed on the end face 37 in an area opposite one of the proximity sensors 39. If the corresponding, first proximity sensor 39 now detects no distance or an excessive distance due to the opening, while the other, second proximity sensor 39 detects a preset distance for the correct tool position, then the position and alignment of the tool 10 is correct. If the second proximity sensor 39 detects a distance that is greater than the preset distance for the correct tool position and the first proximity sensor 39 continues to detect no distance or a distance that is too great, then the tool is correctly aligned but still in the wrong position. If both proximity sensors 29 detect the preset distance for the correct tool position, the tool 10 is in the correct position but is incorrectly aligned. In this case, the tool 10 should be lowered from the rails 31, rotated 180 degrees around a vertical axis and raised back onto the rails 31 in the correct alignment.

Changing a tool 10 with the tool system according to the present disclosure can be carried out.

First, the tool 10 is moved onto the swap body vehicle 30, whereby the tool 10 is pushed over the rails 31 to the end stops 32 via the rail wheels. The tool 10 can have corresponding handles 13 to facilitate manual movement of the tool 10. As soon as the tool 10 rests against the end stops 32, it can be locked to the swap body vehicle 30 on an opposite side via a locking element, for example in the form of a spring-loaded bolt. The swap body vehicle 30 can include a corresponding latching holder for the locking element, whereby this can be designed in such a way that the locking element automatically latches into the latching holder due to its spring load. The tool 10 is thus secured on the swap body vehicle 30.

The swap body vehicle 30 can then be moved to the production system, in particular to the lifting and centering unit 20. To do this, workers can grip the swap body vehicle 30 by the handle 34 and push it to the respective position using the pivot-mounted wheels 33. The swap body vehicle 30 is in one example positioned directly in line with the rails 31 of the lifting and centering unit 20 on the lifting and centering unit 20. The centering elements 27, 35 are provided for this purpose, which provide precise positioning of the swap body vehicle 30 on the lifting and centering unit 20.

The centering elements 27, 35 include in particular centering pins 27, which are arranged on the lifting and centering unit 20. The swap body vehicle 30 has corresponding centering guides 35, which in one example form a V-shaped holder. The centering guides 37 can each embrace a centering pin 27, whereby the centering pin 27 slides along the V-shaped holder of the centering guide 35 and thus provides that the rails 31 are aligned with one another when the swap-body vehicle 30 approaches the lifting and centering unit 20.

The locking element, which locks the tool 10 to the swap body vehicle 30, can then be released. The tool 10 can then be moved from the rails 31 of the swap body vehicle onto the rails 31 of the lifting and centering unit 20, in particular the lifting floor 22. The lifting floor 22 is in the lifted position so that when the tool 10 is pushed onto the lifting floor 22, the tool 10 can be pushed over the centering elements 25, in particular the centering pins 26. As soon as the end stops 32 on the lifting floor 22 are reached, the tool 10 is locked with the locking element on the lifting floor 22.

The lifting floor 22 can then be lowered, whereby the tool 10 with the centering openings 36 is lowered onto the centering pins 26 and guided centered to the preset position. As soon as the tool 10 rests completely on the centering elements 25, the lifting floor 22 is lowered further, in one example to about 5 mm below the tool 10. The tool 10 is now in the working position and can be used to fit an interior component with connector clamps

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A tool system for fitting interior components with connector clamps, comprising:
a tool configured to hold an interior component to be fitted with connector clamps; and
a lifting and centering unit configured to hold the tool, the lifting and centering unit including a lifting element configured to lift the tool from a working position into an alternating position and a centering element configured to center the tool in the working position.

2. The tool system according to claim 1, wherein the lifting and centering unit has a lifting floor configured to lift and lower the tool, which is controllable in such a way that the tool is movable onto centering pins of the lifting and centering unit and the lifting floor is releasable from the tool.

3. The tool system according to claim 2, wherein the lifting floor has rails configured to hold and transfer the tool to a swap body vehicle.

4. The tool system according to claim 1, wherein the lifting and centering unit includes rails configured to hold and transfer the tool to a swap body vehicle.

5. The tool system according to claim 1, further comprising a swap body vehicle configured to hold the tool in the alternating position.

6. The tool system according to claim 5, wherein at least one damping element for the tool is arranged in a region of a longitudinal end of rails associated with the lifting and centering unit.

7. The tool system according to claim 6, wherein the at least one damping element includes a preliminary bearing to absorb transverse forces when a lifting floor associated with the lifting and centering unit is released from the tool.

8. The tool system according to claim 1, wherein the lifting and centering unit includes rails and in a region of a longitudinal end of the rails, the lifting and centering unit includes at least one proximity sensor configured to detect a position of the tool on the lifting and centering unit.

9. The tool system according to claim 8, wherein the at least one proximity sensor comprises two proximity sensors arranged in parallel, and the tool has an opening corresponding to each of the two proximity sensors, and each of the two proximity sensors is signal-connected to a control system so that a correct alignment and position of the tool on the lifting and centering unit is detectable in the alternating position.

10. The tool system according to claim 1, wherein the lifting element that is configured to lift the tool from the working position into the alternating position comprises at least one lifting cylinder and a guide arranged parallel to the at least one lifting cylinder.

11. The tool system according to claim 1, wherein the lifting and centering unit and the tool each have a uniform interface for electrical and pneumatic connection.

12. The tool system according to claim 1, wherein at least one of the tool or the lifting and centering unit has at least one movable locking element configured to lock the tool on at least one of the lifting and centering unit or on a swap body vehicle.

13. The tool system according to claim 12, wherein the at least one movable locking element is spring loaded.

14. The tool system according to claim 1, wherein the lifting and centering unit includes a lifting part with the lifting element, a lifting floor and a centering part with the centering element, and at least the lifting part of the lifting floor is configured to be arranged on the centering part in two positions rotated by 180 degrees about a vertical axis.

15. The tool system according to claim 1, wherein the tool is configured to hold various interior components, which interact with the lifting and centering unit and at least one swap body vehicle for changing the tool.

16. A method for changing a tool of a tool system, comprising:
lifting of a lifting floor via a lifting element of a lifting and centering unit into an alternating position,
pushing a tool onto the lifting floor,
detecting an alignment and position of the tool on the lifting and centering unit via a proximity sensors,
positioning the tool at a preset distance from the proximity sensors,
locking the tool on the lifting floor,
lowering the lifting floor via the lifting element until the tool is positioned on a centering element, and
further lowering the lifting floor to completely relieve the tool.

17. The method according to claim 16, wherein after the lifting floor has been lifted and before the tool is pushed on, a previously inserted tool is removed from the lifting floor and pushed onto a swap body vehicle.
